(19) United States
(12) Patent Application Publication
(10) Pub. No.: US 2002/0099605 A1
(43) Pub. Date: Jul. 25, 2002

(54) Search engine with demographic-based advertising

(75) Inventors: Aaron Weitzman, Huntington Woods, MI (US); David Weinberg, Birmingham, MI (US); Sergiy Volotskiy, Troy, MI (US)

Correspondence Address: DAVID S. BIR, Brooks & Kushman P.C., 22nd Floor, 1000 Town Center, Southfield, MI, 48075-1351, US

(73) Assignee: SearchCactus, LLC, Troy, MI

(21) Appl. No.: 09/969,390

(22) Filed: Oct. 1, 2001

Related U.S. Application Data
(60) Provisional application No. 60/238,879, filed on Oct. 6, 2000.

(51) Int. Cl. G06F 17/60

(52) U.S. Cl. 705/14

(57) ABSTRACT

A system and method for electronic advertising using a search engine include providing an incentive to users of the search engine to become members, collecting demographic information from users while registering to become a member, and associating the demographic information with an advertisement when a user responds to the advertisement. The method may also include providing advertisers with statistical information relative to user demographics for users who responded to a particular advertisement. In one embodiment, the member demographics may be used by advertisers to target particular advertising campaigns to members based on member demographic information. Likewise, demographic information entered by advertisers may be used by the administrator or other advertisers to target advertising information to those advertisers using the search engine. An advertiser determines a target audience based on selected demographic information and is charged based on the number of selected members which meet the advertisers demographic selection criteria. If the advertisement includes a link to the advertiser, the search engine tracks the response or click-through rate. Banner ads or text areas on the search engine website may also be presented based on search terms entered by a user or member with click-through rates determined by the search engine.

### TECHNICAL FIELD

The present invention relates to a system and method for integrating demographic-based advertising with a search engine for searching computer networks, such as the Internet.

### BACKGROUND ART

Computer networks, including the Internet, provide access to a wealth of information without the obstacle of a physical or geographic boundary. The overwhelming amount of available information often makes it unusable absent a method for finding information of particular interest to a user. As such, a number of search engines have been developed to discover new information available on the network and index the information using key words or search terms so that the information can be located and retrieved by users. Depending upon the particular methods used to discover new information and catagorize it within a searchable database, different search engines may provide varying results for the same or similar search terms. Meta search engines have also been developed to automatically search multiple search engines or databases based on the same search terms or key words.

Providers of products and services typically attempt to target their advertising to reach those users most likely to make a purchase. A number of Internet search engines provide targeted advertising by displaying banner ads based on search terms entered by a user. Because users typically visit or “click-through” to only a few of the search results, vendors seek to be listed at or near the top of the results listing. As such, some search engines allow advertisers to pay to be listed on the first page of the search results for particular search terms. While these strategies help advertisers to reach their targeted audience, advertisers have no feedback with respect to which users are clicking-through or visiting their website, i.e. the user profile or demographic information of the user. Furthermore, advertisers typically pay based on each “hit” or each time their listing is presented to a user. Alternatively, advertisers may pay based on the number of users who are referred from another website (including a search engine website).

Another increasingly popular method (for advertisers) of electronic advertising is through email. However, the enormous increase in unsolicited email, also referred to as “spam,” has reduced its effectiveness with consumers. Furthermore, email lists may be unreliable in terms of the target market because email addresses are often collected and distributed without the user's knowledge. In addition, the recent spread of computer viruses via email has made many user's suspicious of opening any unsolicited email which does not come from a recognized source.

### DISCLOSURE OF INVENTION

It is an object of the present invention to provide a system and method for advertising or marketing using email based on user demographics.

Another object of the present invention is to provide a search engine which gathers user demographic information for use in targeted email.

A further object of the present invention is to provide a system and method for charging advertisers based on the advertiser's bid for placement in a search result listing relative to other advertisers.

Another object of the present invention is to provide a system and method for supplying advertisers with demographic information for users who respond to an advertisement.

A further object of the present invention is to provide a search engine having a bid calculator for advertisers to determine an appropriate price for relative placement in a search results listing.

An additional object of the present invention is to provide advertisers with detailed statistics based on demographic information of users who respond to a particular advertising campaign using banner ads or email.

A further object of the present invention is to provide a system and method for encouraging consumers to use a particular search engine for searching the Internet.

A still further object of the present invention is to provide a search engine website which pays members who click-through to advertisers' websites for at least a predetermined amount of time.

Another object of the present invention is to provide a system and method for charging advertisers based upon user responses to a particular ad or result listing.

An additional object of the present invention is to provide a system and method for targeted opt-in email campaigns from advertisers based on member demographics.

In carrying out the above objects, and other objects, features, and advantages of the present invention a method for electronic advertising using a search engine includes providing an incentive to users of the search engine to become members, collecting demographic information from users while registering to become a member, and associating the demographic information with an advertisement when a user responds to the advertisement. The method may also include providing advertisers with statistical information relative to user demographics for users who responded to a particular advertisement. In one embodiment, the member demographics may be used by advertisers to target particular advertising campaigns to members based on member demographic information. Likewise, demographic information entered by advertisers may be used by the administrator or other advertisers to target advertising information to those advertisers using the search engine. An advertiser determines a target audience based on selected demographic information and is charged based on the number of members which meet the advertisers demographic selection criteria. If the advertisement includes a link to the advertiser, the search engine tracks the response or click-through rate. Banner ads or text areas on the search engine website may also be presented based on search terms entered by a user or member with click-through rates determined by the search engine. A system for implementing various methods according to the present invention is also provided.

The present invention provides a number of advantages. For example, the present invention provides advertisers with demographic statistics relative to users who respond to a particular advertisement. As such, the present invention provides for more targeted advertising so resources can be allocated to those campaigns which reach the intended recipients who respond to the advertisement. The present invention also provides an incentive for users to register as members and provide the demographic information by paying users for responding to advertisements. The present invention may reduce advertising costs by charging advertisers only after a user or member meets various charging criteria, such as spending a minimum amount of time viewing the advertiser's website, for example.

The above advantages and other advantages, objects, and features of the present invention are readily apparent from the following detailed description of the best mode for carrying out the invention when taken in connection with the accompanying drawings.

### BRIEF DESCRIPTION OF DRAWINGS

FIG. 1 is a block diagram illustrating operation of the member functions for one embodiment of a system or method according to the present invention;

FIG. 2 is a block diagram illustrating operation of the advertiser functions for one embodiment of a system or method according to the present invention;

FIG. 3 is a block diagram illustrating operation of the administrator functions for one embodiment of a system or method according to the present invention;

FIG. 4 illustrates a search engine results list according to one embodiment of the present invention;

FIG. 5 illustrates the functionality of an advertiser's listings for a search engine according to one embodiment of the present invention;

FIG. 6 illustrates the functionality of adding a new listing for an advertiser to a search engine according to one embodiment of the present invention;

FIG. 7 illustrates operation of a search engine bid and keyword management function according to one embodiment of the present invention;

FIG. 8 illustrates operation of a bid calculator used to determine a price for placement in a search results listing relative to other advertisers for a particular keyword according to one embodiment of the present invention;

FIG. 9 illustrates an advertiser's banner ads with related statistics for a search engine with integrated advertising according to one embodiment of the present invention;

FIG. 10 illustrates banner ad management functions for an advertiser on a search engine according to one embodiment of the present invention;

FIG. 11 illustrates an advertiser statistics summary report for a search engine according to one embodiment of the present invention;

FIG. 12 illustrates a detailed demographic report for a search engine advertisement according to one embodiment of the present invention;

FIG. 13 illustrates a statistics summary for a direct email campaign according to one embodiment of the present invention;

FIG. 14 illustrates selection of demographic criteria for an email advertising campaign according to one embodiment of the present invention;

FIG. 15 illustrates selection of geographic criteria for an email advertising campaign according to one embodiment of the present invention;

FIG. 16 illustrates selection of more specific geographic criteria for an email advertising campaign according to one embodiment of the present invention;

FIG. 17 illustrates selection of additional demographic criteria for an email advertising campaign according to one embodiment of the present invention; and

FIG. 18 illustrates preparation of an email advertisement including determination of price and quantity based on demographic criteria according to one embodiment of the present invention.

### BEST MODE FOR CARRYING OUT THE INVENTION

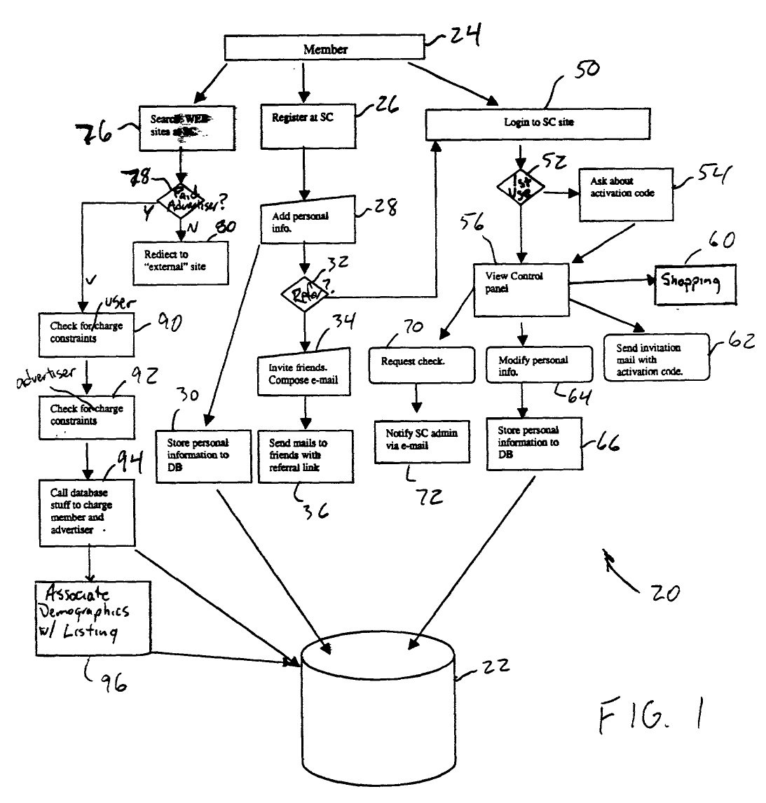

Referring now to FIG. 1, a block diagram illustrating operation of the member or registered visitor functions for one embodiment of a system or method according to the present invention is shown. System 20 preferably includes a computer readable storage medium 22 for storing data representing instructions executable by a computer to perform the various functions illustrated and described with reference to the invention. In addition, storage device 22 may be used to store various data associated with registered visitors or members and advertisers as will be appreciated by those of ordinary skill in the art. Storage device 22 preferably includes at least one database with appropriate interface software for the structured query language (SQL). Storage device 22 represents one or more such computer readable storage media and may be an integral or separate part of a computer, computer system, or network. In one preferred embodiment, storage device 22 forms part of the server or server farm to provide access via a computer network, such as the Internet. In this preferred embodiment, storage device 22 is accessible by members and advertisers via the Internet and includes software to implement the system and method of the present invention. Registered visitor or member module 24 is used to provide an incentive to users of the search engine to obtain demographic information as explained in greater detail below. In one embodiment, users are compensated for responding or clicking on advertisements which are sponsored by paid advertisers. Depending upon the particular application, the advertisements may be in the form of banner ads, or a search results listing which includes advertiser listings in response to a search term entered by the user.

While member module 24 is primarily directed to obtaining and servicing registered visitors or members of the search engine, any user may use the search engine to identify resources of particular interest on the computer network. Where the computer network includes the Internet, the search engine preferably provides links to various websites on the Internet in response to the user entering a search query. Unregistered visitors or users may use the search engine as represented by block 76. Upon entering the search term or query, a corresponding search of one or more databases such as those stored in storage device 22 is completed. The search may include databases which are accumulated and indexed by various other search engines or computers on the network. Alternatively, the search may be limited to the particular database located on the computer providing the search engine interface. In one preferred embodiment, the search term or query entered by the user is used to search a database stored on storage device 22 in addition to one or more search engines available on the Internet. The database stored on storage device 22 includes advertiser listings with associated keywords or phrases. If one or more of the advertiser listings stored in the database on storage device 22 match the search term or query as indicated by block 78, those listings appear before any listings which are not paid for by advertisers. If none of the keywords or phrases associated with the advertiser listings match the search term or query, the listings are provided by an external website or search engine as indicated by block 80.

The search results are displayed with paid advertisers arranged in an order corresponding to their bid for placement associated with a particular keyword which matches the search term. The user then activates or responds to a particular listing by clicking on the associated link which redirects the user to the associated website or computer as represented by block 80. For listings corresponding to paid advertisers as determined by block 78, block 70 determines whether various criteria or charge constraints have been satisfied. The charge constraints or criteria may be used to impose a maximum number of credits for a predetermined time period for each registered visitor. Likewise, members may be limited to a predetermined number of sponsors to a particular advertiser's website in a predetermined period. In one preferred embodiment, members must visit or view the selected website for a predetermined time, such as 20 seconds or more, to receive credit for visiting the advertiser. Similar charge constraints imposed on members may also be imposed for advertisers, i.e. an advertiser account is not charged unless certain criteria or constraints are satisfied. In one preferred embodiment, the advertiser is charged only once for a particular user, whether or not registered, in a particular time period, such as 24 hours. Likewise, advertisers are preferably charged only if a visitor (registered or anonymous) clicks on a listed link and visits the associated website for a predetermined time period, such as 20 seconds or more. For registered visitors or members, the user account is credited and the advertiser account is debited as represented by block 94 if the corresponding charge constraints represented by blocks 90 and 92 are satisfied. For registered users or members, the user demographic information is associated with the advertisers' listing as represented by block 96. The demographic information may be provided to advertisers in the form of summary statistics as described in greater detail below. Preferably, all personal and identifiable information is kept strictly confidential to the search engine and is not provided to the advertisers.

Visitors to the search engine are encouraged to register as represented by block 26. Preferably, an incentive is provided to encourage users to register so that demographic information may be voluntarily collected. In one preferred embodiment, a user's account is credited upon registration. The user may accumulate additional credits or compensation by responding to various advertisements as explained in greater detail below. As part of the registration process, personal information is collected as represented by block 28. The personal information preferably includes sufficient information to eliminate duplicate accounts or a particular user and to provide the option for mailing the user a check when requested and the user's account accumulates a sufficient amount of credit. Typical personal information may include name, address, phone number, and the like. In one embodiment, the personal information includes at least an email address and demographic information which is voluntarily provided by the user during registration. Representative demographic information may include the user's age group, occupation, gender, marital status, hours spent online per week, primary residence, children per household, education level, income levels, number of online transactions completed, and hobbies. Of course, various other information may be collected based upon the particular application. To establish a member or registered visitor account, a unique user name and password may be selected or assigned by the system. The personal information, along with the user name and password, is then stored to a database as represented by block 30.

To generate additional credits or compensation for registered users, the user may be prompted to refer other users to the search engine as indicated by block 32. An appropriate email message may be composed and forwarded to those users as represented by blocks 34 and 36, respectively. Preferably, the email message includes a link to the search engine website along with a referral code such that the user receives a percentage or commission for revenue generated by his or her referrals.

After providing the required personal information, an activation code is sent, preferably by email, to the new registered member to authenticate a subsequent log-in to the search engine site. The member is then prompted to log-in as represented by block 50. Upon the first use or log-in as determined by block 52, the visitor is prompted to enter the activation code previously sent by email as represented by block 54. The activation code is compared to the information associated with the user account and stored in the database of storage device 22. Upon successful entry of the activation code, the registered visitor control panel is displayed as indicated by block 56. A number of options are then available to the registered user.

One option available in a preferred embodiment of the present invention for registered users is to shop or purchase products and/or services from the search engine as represented by block 60. The purchase of products and/or services is preferably based upon the accumulated credits for the user. Of course, the user may purchase items in excess of the available credits by providing appropriate payment information, such as a credit card, bank account number, and the like.

Registered visitors may send invitations to various other computer users with an appropriate activation or referral code as represented by block 62. As indicated above, referrals generated by a registered member preferably compensate the registered member based on a portion of the revenue generated by the referral.

Control panel 56 also preferably includes an option for the registered visitor to modify personal information which may include the demographic information, mailing address, email address, and password, for example, as represented by block 64. Any updated or changed information is then stored in the database as represented by block 66.

Registered users may request an account payout as represented by block 70. Preferably, users must obtain a minimum account balance prior to requesting payment. Payment may be in the form of a check or via electronic fund transfer (EFT) depending upon the particular application. Payment requests generated as represented by block 70 are preferably forwarded to a system administrator as represented by block 72 for approval. Approved payment requests are then effected manually or automatically based on the response of the system administrator.

Thus, when a new user visits the search engine website and wants to receive the incentive for responding to the advertisement, she must first register and establish a member or registered visitor account. During the registration process, the visitor selects or is assigned a unique user name and password which allows the user to log-in to view accumulated credits, change personal information, etc. During registration, demographic information is captured and subsequently associated with a particular advertisement when a member responds to the advertisement by activating or clicking a link. Provided the charge constraints are satisfied, registered members receive credits for each advertiser link displayed and responded to as a result of the search terms entered by the user. When the user accumulates enough credits in her account, she may request payment in the form of a check, funds transfer, or the like.

The charge constraints or criteria for the users and advertisers are intended to prevent visitors from fraudulently accruing credits. Examples of various constraints to prevent fraud have been described above. Of course, other constraints may be necessary or desirable. However, the present invention is intended to reduce the costs of advertisers who preferably pay only for those users who actually respond to the advertisement by clicking on the associated link. Both registered and unregistered visitors' identity is tracked to prevent the same visitor from depleting an advertiser's account. Preferably, automatic identification means are provided to identify registered users, such as cookies. Similar information may be obtained from “anonymous” users based on IP address, for example.

View 2 is a block diagram illustrating operation of the advertiser functions for one embodiment of a system or method according to the present invention. The advertiser module indicated generally by reference numeral 100 allows advertisers to register or become members as represented by block 102. Similar to the user registration, during the registration process the advertiser enters personal identifying information and company information as represented by block 104. The personal information may also include similar demographic information as that described with reference to the user registration process. The advertiser is assigned or selects a user name and password during registration for subsequent log-in to the site. The advertiser may then add one or more website listings as represented by block 106 and explained in greater detail with reference to blocks 130 and 132. To establish an account, an advertiser must provide payment information as represented by block 108. As with the user registration process, the advertiser registration process is preferably completed using a secure connection over a telephone and/or computer network. As represented by block 108, payment may be made by credit card, check, or other arrangements for electronic transfer of funds. If payment is provided by check, the advertiser's account is held for approval as represented by block 110. Credit card payments may be validated by a third party payment service as represented by block 112. The registration information and payment information is used to set up an advertiser account preferably stored in a database on storage medium 22.

Block 114 determines whether the credit card information is valid and reports an error if appropriate information has not been entered as indicated by block 116.

During registration or upon subsequent log-in to the site as an advertiser, the advertiser may add and/or modify one or more web listings as represented by block 130. Each web listing includes an associated link or URL (universal resource locator), title, and brief textual description. In addition, various P keywords relevant to the listing may be provided as explained in greater detail with reference to blocks 150-154.

Additional payments may be made by the advertiser as represented by block 136. The payments are credited to the advertiser's account. Depending upon the particular advertising campaigns, the advertiser's account is debited each time a user responds to a particular advertisement and/or when the mail messages are sent as described in greater detail below. Before a new or modified listing will appear in response to a user's search query, the system administrator must approve the listing as represented by block 134. Preferably, the system administrator reviews the listing for an appropriate title and matching description along with keywords that re relevant to the particular listing. Upon approval, the listing will appear in response to subsequent user queries which include church terms (????) matching the associated keywords of the web listing.

Advertiser module 100 allows advertisers to add and/or modify keywords associated with each listing as represented by block 150. According to the present invention, each keyword includes an associated bid as represented by blocks 152 and 154. The present invention allows the advertiser to choose as many keywords (which are relevant to the listing and subject to administrator approval) and assign a bid price for placement in a search results list for a particular keyword relative to other advertisers and unpaid listings. A bid calculator allows the advertiser to modify bid prices and determine where the listing will appear relative to other listings for a particular keyword as explained in greater detail below. For example, an advertiser that selects “computer” as a keyword will find that their current bid price of $0.10 will rank their associated website 20^{th} in the results for a search query which matches that keyword. The advertiser is provided the opportunity to increase the bid price for that keyword to appear higher in the results list. Advertisers selecting the same keyword and same bid price are preferably listed so that the first registered advertiser appears higher in the list.

Another feature of advertiser module 100 includes the ability to provide electronic messaging via email as indicated by block 170. The advertiser selects criteria for mail list recipients as represented by block 172. The criteria preferably includes at least some of the demographic information collected from the users during the registration process. After selecting the criteria, the system searches the database stored on storage device 22 to determine the number of registered users which match or meet the criteria. Preferably, a price for providing email to all of the registered users matching the criteria is displayed and the advertiser has the opportunity to reduce the number of recipients by either changing the selection criteria or sending email to only a selected number of the recipients matching the selection criteria. After determining the number of recipients, the electronic advertising message is composed as represented by block 174. A selected mailing list and advertisement is then submitted to the system administrator for approval as represented by block 176. Upon approval, the mail list information and recipients list is stored in the database as represented by block 178. The system then forwards the advertiser's message to the selected recipients without providing the email addresses or any other personal information to the advertiser.

According to the present invention, the electronic advertising message preferably includes a link associated with the advertiser by the search engine. The associated link allows the search engine to track the number of users who respond to the particular message and provide this information along with associated demographic information to the advertiser.

Advertiser module 100 also includes the option of purchasing a banner ad as represented by block 190. Preferably, banner advertisements are entered by specifying an associated link or URL, keywords, and an associated image as represented by block 192. Multiple banners having the same keyword are displayed in sequence in response to the search terms of a user query. The banner information may then be added to a banner directory as represented by block 194. According to the present invention, demographic information of registered users may be associated with a particular banner advertisement when the user responds to the ad by clicking on the banner, for example. The demographic information is associated with the particular banner and stored for subsequent analysis in a database on storage media 22.

Advertising module 100 also allows registered advertisers to view statistics for various advertising campaigns as represented by block 200. In one embodiment, advertising campaigns may include web listings which appear in a search results list in response to search terms entered by a registered user or visitor, banner advertisements, and direct electronic messaging or email campaigns. Various demographic information associated with the advertising campaigns is aggregated and displayed in summary statistics as represented by block 202. As illustrated, the information is preferably stored in a database and selected by appropriate structured query language (SQL) commands as known by those of ordinary skill in the art.

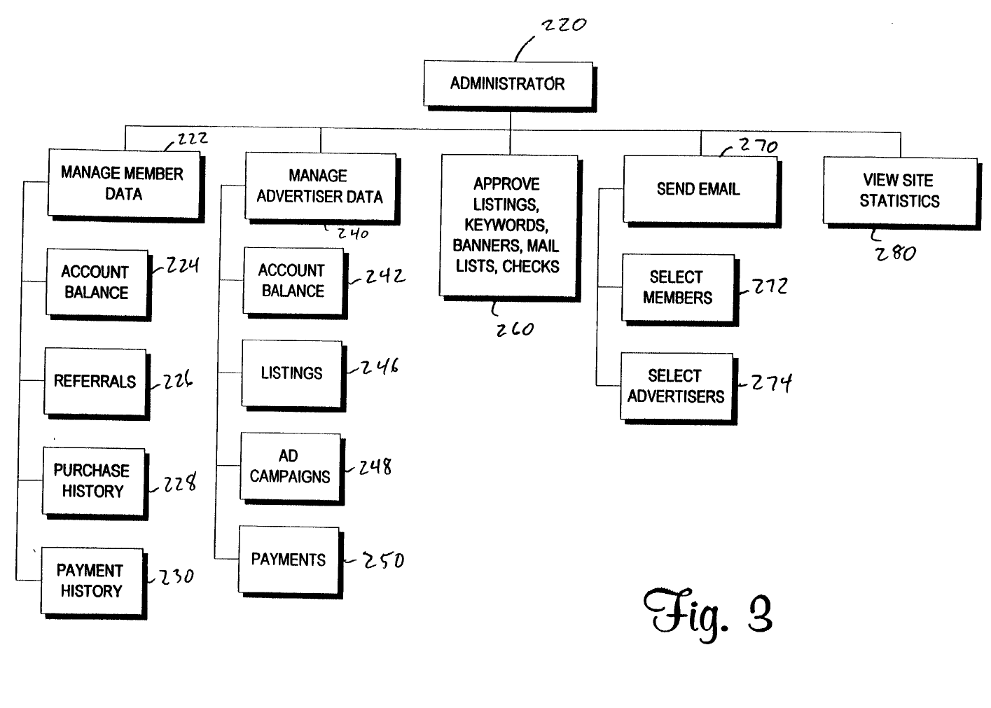

FIG. 3 is a block diagram illustrating operation of various administrator functions for one embodiment of a system or method according to the present invention. Administrator functions, represented generally by reference numeral 220, include tools and/or interfaces for managing various aspects of the search engine with demographics according to the present invention. The system administrator preferably accesses the system via an appropriate user name and password to gain access to the administrator functions. The administrator can manage member data as represented by block 222. This may include monitoring of account balances as represented by block 224. In addition, the administrator may view the associated members which have been referred by a particular member as represented by block 226. Likewise, any credits associated with referrals may be viewed or managed by the administrator. Block 228 represents the purchase history information for a particular member. The administrator preferably can view the purchases made by a particular member using credits obtained by searching using the associated search engine and responding to links of paid advertisers. In addition, the administrator preferably can view the payment history for a particular member including the form of payment (check, credit card debit, electronic funds transfer, etc.), when payment was requested, and/or when payment processing was completed.

Administrator functions 220 of FIG. 3 preferably include ability to manage advertiser data as represented by block 240. This may include similar functions as those for the member data management represented by block 222. In particular, the administrator preferably has ability to monitor account balances as represented by block 242. In addition, the administrator can view search engine listings, ad campaigns, and payment as represented by blocks 246, 248, and 250, respectively.

Administrator functions 220 also include the ability to approve new and/or modified listings as represented by block 260. Preferably, any changes to listings which includes the associated link, description, and keywords are submitted to the administrator for approval prior to becoming active in the search engine database. Likewise, the recipient list, electronic message, and associated link (if any) generated during the direct email feature of the present invention are submitted to the administrator for approval prior to being completed by the system. In addition, any payment requests are preferably approved by the administrator prior to processing. Administrator approval of advertising campaigns maintains the integrity of the system and reduces the likelihood of alienating any members based on inappropriate advertising.

Additional features of the administrator functions represented by block 220 of FIG. 3 include the ability to send informational or other email as represented by block 270. Email may be generated and forwarded to selected members as represented by block 272 and/or selected advertisers as represented by block 274. Administrator functions 220 also provide for the generation of site statistics as represented by block 280. Site statistics may include the number of registered users and advertisers, number of searches performed, average account balances, etc.

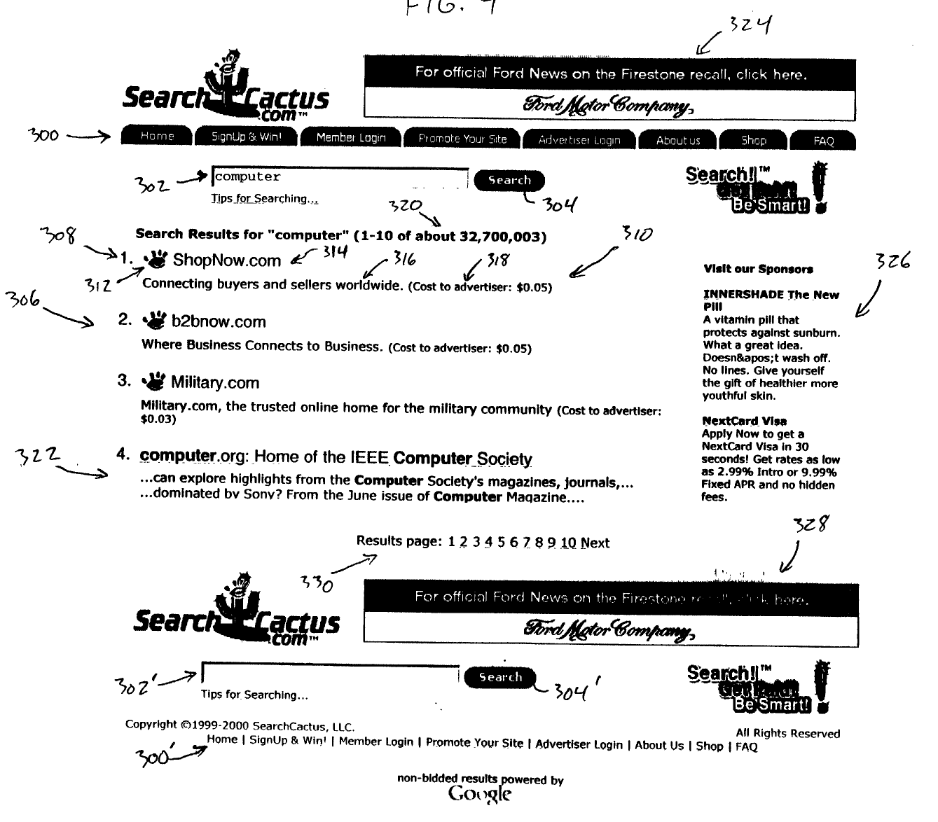

FIG. 4 provides a representative output for a search engine results list according to one embodiment of the present invention. The search results listing page preferably includes a navigation menu 300 near the top of the screen having associated buttons or links to quickly access various site functions. A text navigation 300′ is also preferably provided near the bottom of the screen. A search query or search terms window 302 may be provided with associated activation button 304. The search window is used by a visitor to enter a search term or query. An additional window and activation button 302′ and 304′, respectively, may also be provided toward the bottom of the screen.

After the user enters a search term or query and activates the search button, the present invention searches the database of paid advertisers in addition to one or more databases of unpaid listings (which may include one or more other search engines) to provide the results, indicated generally by reference numeral 306. Each listing in response to the search term or query preferably includes a ranking number 308 and associated description text indicated generally by reference numeral 310. According to the present invention, listings sponsored by advertisers are indicated by a special icon 312. This allows the registered visitor or member to determine which listings are sponsored and will result in a credit to the visitor's account provided the corresponding charge constraints are satisfied when the visitor responds to the advertisement or listing by clicking on the associated link 314. The visitor may also determine the relevance of the results based on the description 316. Preferably, the visitor is also provided with cost information 318 which indicates the price the advertiser is willing to pay to the search engine for each visitor which responds to the listing or advertisement. Listings 306 are preferably arranged with listings sponsored by advertisers preceding those which are not sponsored, such as listing 322. In addition, advertiser listings are preferably arranged according to the bid price entered by the advertiser for the particular keyword which matches the search term or query entered by the user. For advertisers which bid the same price for the same keyword, listings are preferably arranged based on the order in which the advertisers entered the listings. Of course, other arrangements for listing the results may be provided. In addition, the icon 312 and cost information 318 may be omitted without departing from the spirit or scope of the present invention.

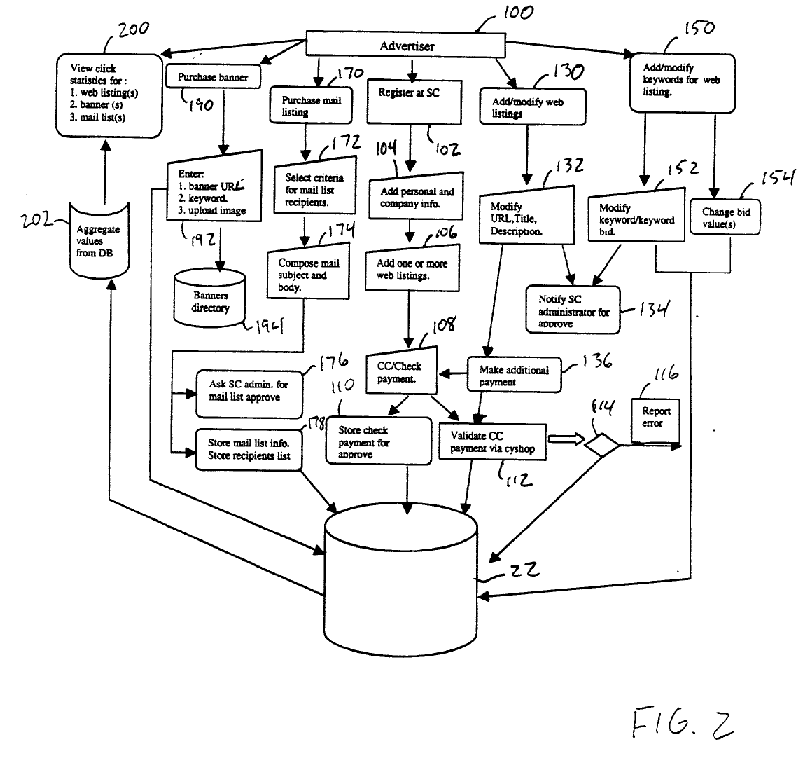

As described above with reference to FIGS. 1 and 2, when a user responds to an advertisement or listing, the user's demographic information is associated with that particular listing. This demographic information may then be provided to the advertiser. Each time the user responds to an advertisement, and meets the arch constraints, the advertiser is charged or debited the associated bid price and the user receives a predetermined credit.

In addition to the search results listing 206, the search engine preferably includes a number of additional areas for advertising. For example, banner ad areas 324 and 328 may display advertisements based on the search term or query entered by the user. Alternatively, or in addition, one or more banner ad areas may randomly rotate through the banner ads in the banner directory. Likewise, text-based advertising 326 may be provided from the search engine or from an external site. The text-based advertising 326 preferably includes links to the associated advertisers' websites. When a registered user or registered visitor responds to an advertisement such as a banner ad 324, 328 or text-based ad 326, the user's demographic information is associated with that advertisement. The demographic information is then subsequently provided to the advertiser and may be used to analyze the effectiveness of a particular advertising campaign relative to its intended target audience.

The search engine results preferably includes additional informational and/or navigational aids to assist the user in locating relevant results. For example, results may be organized in one or more results pages with an associated menu 330 to quickly access a particular results page. Additional search results information 320 may also be provided to assist the user in formulating more effective search queries.

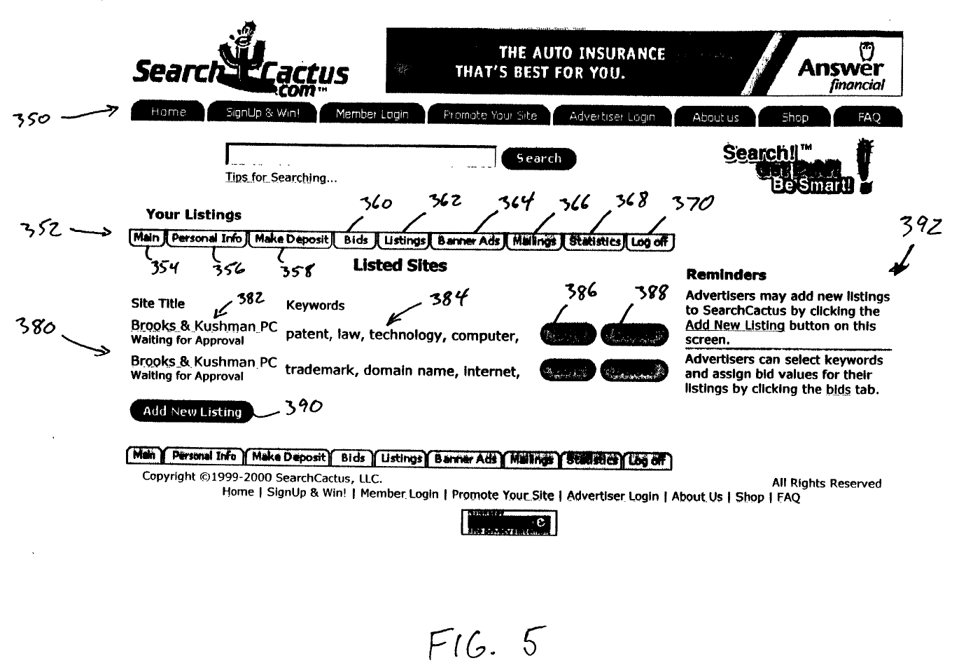

FIG. 5 illustrates operation of one of the features available through the advertiser's module of the present invention. In addition to a main navigational menu 350, a context-sensitive navigational menu 352 may be provided. In this embodiment, context-sensitive navigational menu 352 provides various functions of the advertiser module. Button 354 returns to the main menu. Personal information may be modified using button 356. Advertisers may add credits or money to their accounts using button 358. Likewise, advertisers may modify bid prices associated with various keywords using button 360. Advertiser listings which are provided in response to a user query or search term matching one or more keywords of the advertiser may be modified using button 362.

Additional buttons are preferably provided for managing various aspects of an advertising campaign as illustrated in the embodiment of FIG. 5. For example, button 364 allows the advertiser to manage various aspects of the banner ads. Button 366 provides various management functions for electronic messaging or email campaigns. Button 368 is used to access statistical information associated with one or more advertising campaigns. Button 370 is provided to log off or log out the advertiser.

In addition to main navigational menu 350 and context-sensitive navigational menu 352, various information and buttons are provided for managing advertiser listings as illustrated in the embodiment of FIG. 5. In this embodiment, listings 380 include a title 382 and associated keywords 384. In addition, a description associated with title 382 may be displayed for modification, if desired. Likewise, status information may be provided such as the “waiting for approval” status after submission of a listing and prior to approval by the system administrator. Preferably, various buttons are provided to manage the listings. For example, button 386 may be provided to edit the listing. Editing functions may include modifying or adding keywords and associated bid prices, title, description, and the like. Button 388 provides a delete function to delete the associated listing 380. Preferably, a button 390 is provided to add new listings. Various other features may also be provided to assist the advertiser in managing listings provided on the search engine. For example, a context-sensitive text and/or graphic 392 may be used to provide the advertiser with additional information relative to various management features and functions.

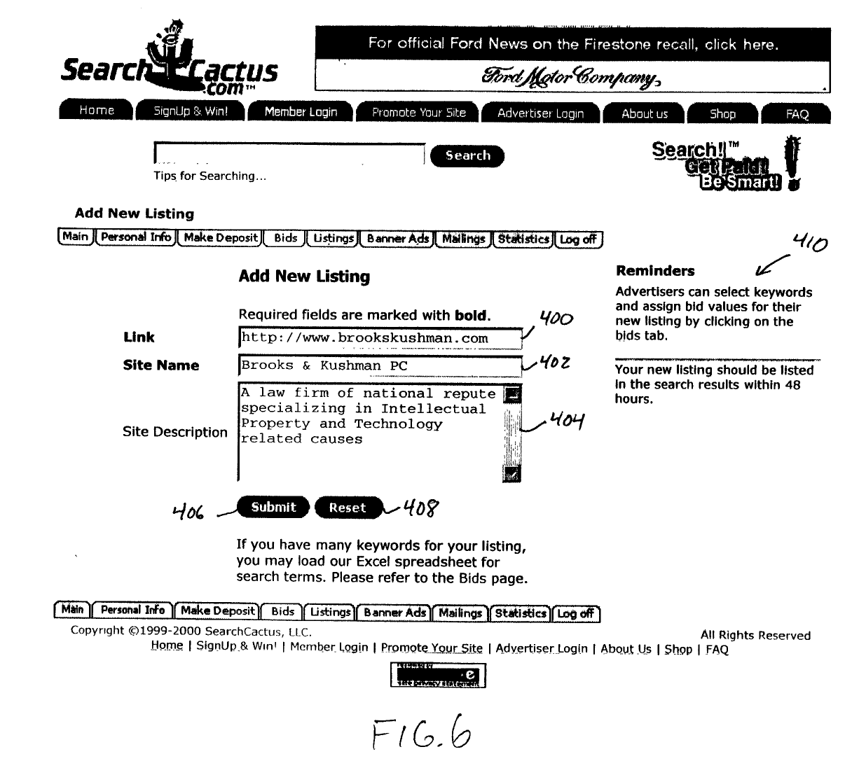

Referring now to FIG. 6, various features of the present invention associated with adding a new advertiser listing are shown. In this embodiment, prompts and associated data entry windows are provided to enter information associated with a particular listing. For example, window 400 is provided to enter the address, domain name, or other identifying information associated with the listing. Preferably, this information is used to connect the user to a computer associated with the advertiser when the user responds to an advertisement or listing by clicking on the associated text or graphic. Block 402 provides a title or site name which appears in the results list in response to a user search query or term. A text window 404 is provided to allow the advertiser to enter an associated description for the listing. After entering the information, the advertiser may click on the submit button 406 or the reset button 408. Submit button 406 submits the modified or added listing for approval by the system administrator. Reset button 408 resets or clears the information in text windows 400, 402, and 404. As described with reference to FIG. 5, an informational area 410 may be provided with context-sensitive information related to the current function, i.e. adding a new listing in this example.

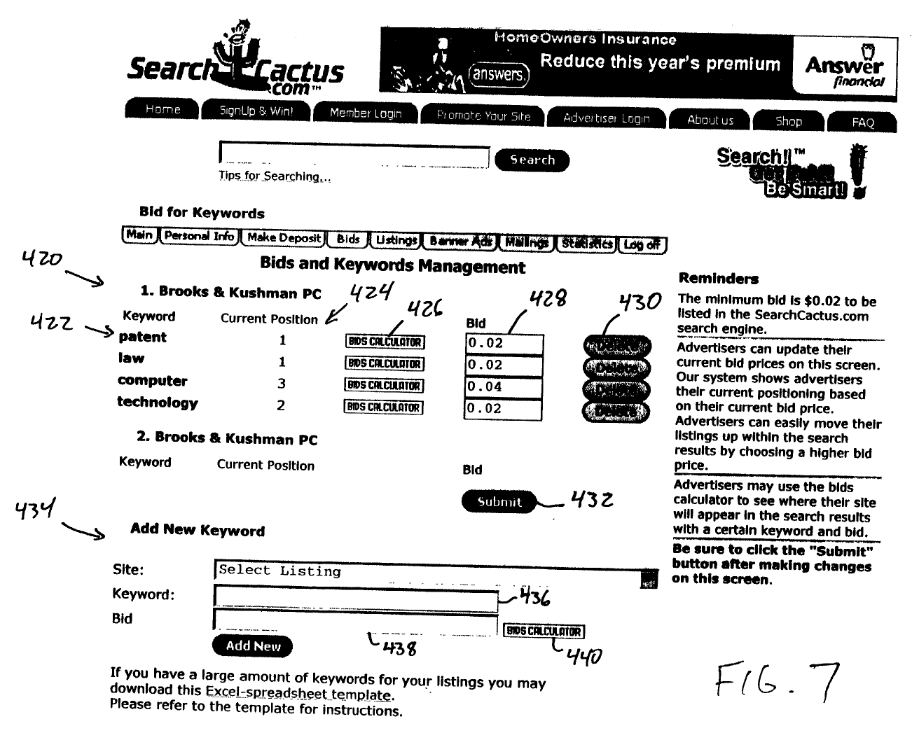

FIG. 7 illustrates operation of a search engine bid and keyword management function according to one embodiment of the present invention. Each listing 420 preferably includes one or more keywords 422 each having an associated position 424 and a bid 428 which may be determined using a bid calculator 426. Button 430 may be used to delete an associated keyword 422 from the listing 420. Current position 424 is determined based on the bid 428 for keywords 422 relative to bids placed by other advertisers. Position information 424 indicates the relative position that the listing 420 will appear in a search results listing for a query containing the associated keyword. After entering or changing bids 428, the advertiser uses the submit button 432 to have the updated position information 424 displayed. The system uses modified or newly added bid information 428 to determine the relative position 424 for each keyword 422 upon clicking the submit button 432.

As also illustrated in FIG. 7, a function may be provided to add a new keyword represented generally by reference numeral 434. Preferably, keywords are added by selecting a listing 420 from a drop-down menu of previously entered listings. A new keyword may be entered in box 436 with an associated bid entered in box 438. To determine an associated position or placement for a particular keyword and bid, bid calculator button 440 may be used to access an associated bid calculator. Alternatively, a spreadsheet may be used to enter multiple keywords and associated bids. This feature allows advertisers to enter a large amount of keywords for one or more listings. Upon submission of new keywords by clicking on the submit button 432, the modified information is submitted for administrator approval. Once approved, the keywords are activated and will trigger the display of the associated listing 420 for keywords matching one or more search terms entered by the user.

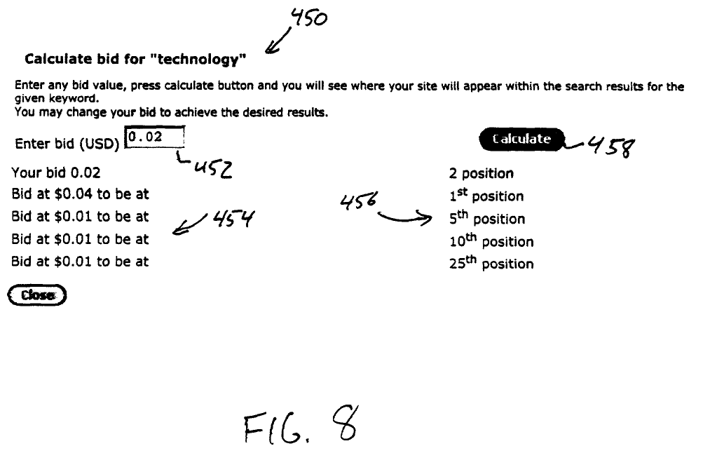

FIG. 8 illustrates operation of a bid calculator used to determine a price for placement in a search results listing relative to other advertisers for a particular keyword according to one embodiment of the present invention. The bid calculator provides the advertiser with bid information relative to other advertisers for a particular keyword as represented by reference numeral 450. The advertiser may enter a bid for the current keyword in box 452. Clicking the calculate button 458 causes the system to perform a search of the database for the keywords 450 and bid prices of other advertisers. Bid prices 454 and associated positions 456 are displayed for the current bid and preferably a selected number of bids to assist the advertiser in selecting an appropriate bid for display at a desired position in the search list.

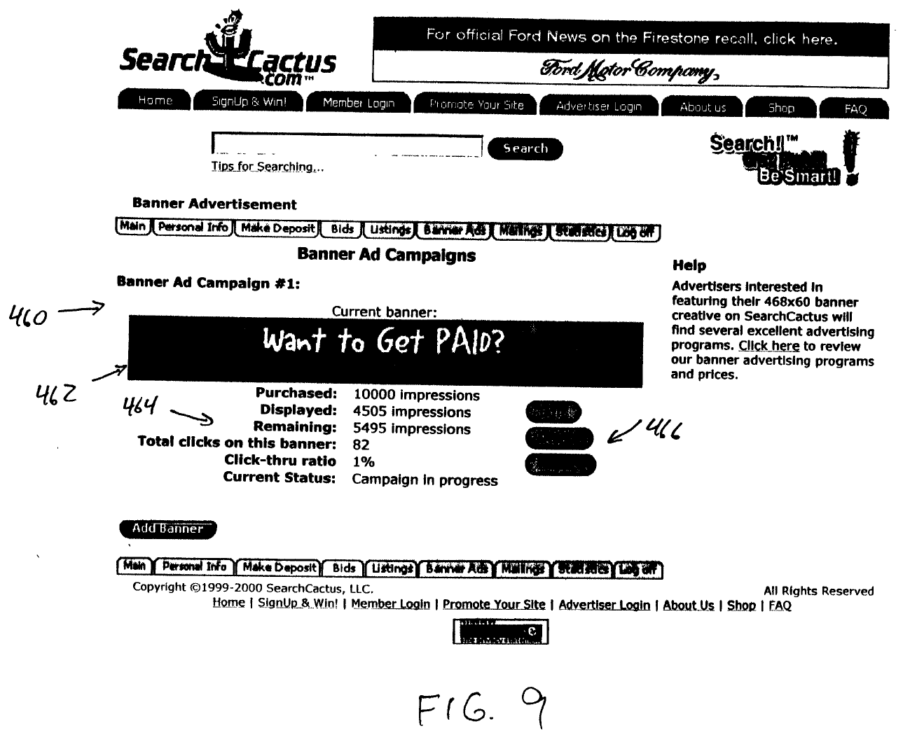

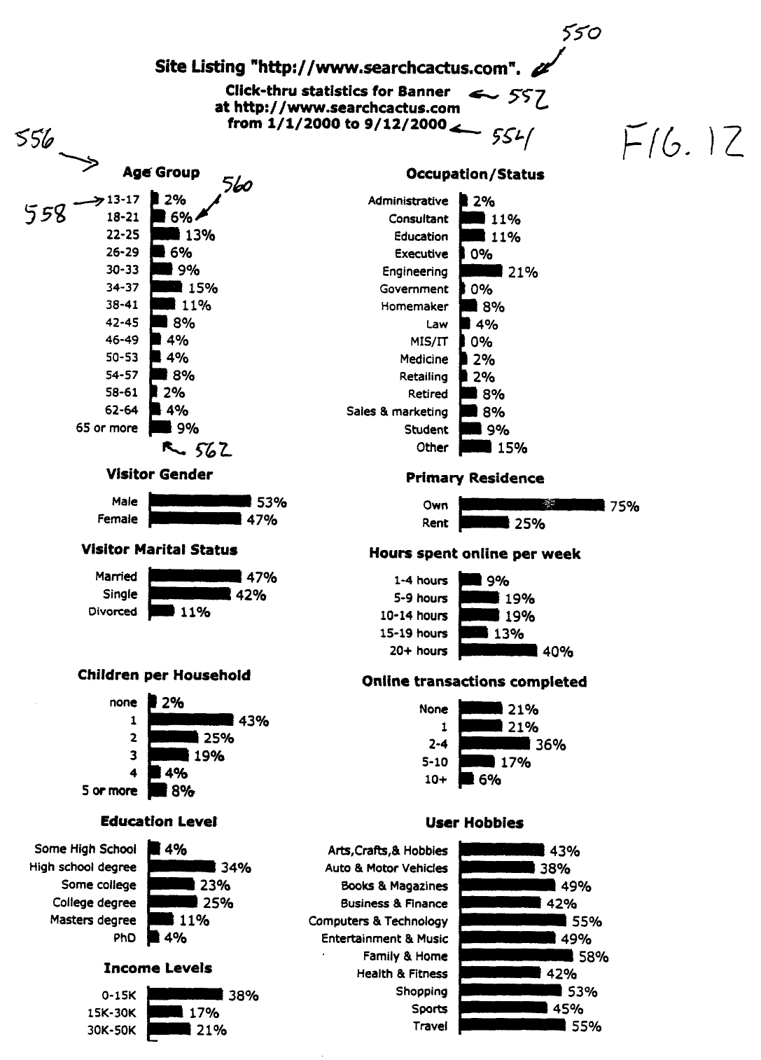

FIG. 9 illustrates an advertiser's banner ads with related statistics for a search engine with integrated advertising according to one embodiment of the present invention. Banner ad listing 460 preferably includes a graphic 462 with associated statistics 464 and management function controls 466. Statistics 464 may include the number of displays or impressions purchased, the number of times the banner ad has been displayed, the number of remaining displays or impressions, the number of user responses or clicks for the banner, the click-through ratio, and the current status of the campaign. The click-through ratio is determined based on the total number of responses or clicks relative to the number of times the banner has been displayed. As described above, each time a user responds or clicks on the banner advertisement, the previously associated user demographic information is linked or associated to the particular banner ad for calculation of summary statistics as illustrated and described with reference to FIG. 12.

Banner ad management buttons 466 preferably includes controls for editing, deleting, and generating a statistical report. Of course, various other controls may be provided depending on the particular implementation. An edition function may be provided to change the graphic 462 and/or associated keywords for banner ad 460. The delete function is used to cancel the ad or suspend the campaign. The report button or control is used to generate a statistical report based on demographic information of users who have responded to the banner ad.

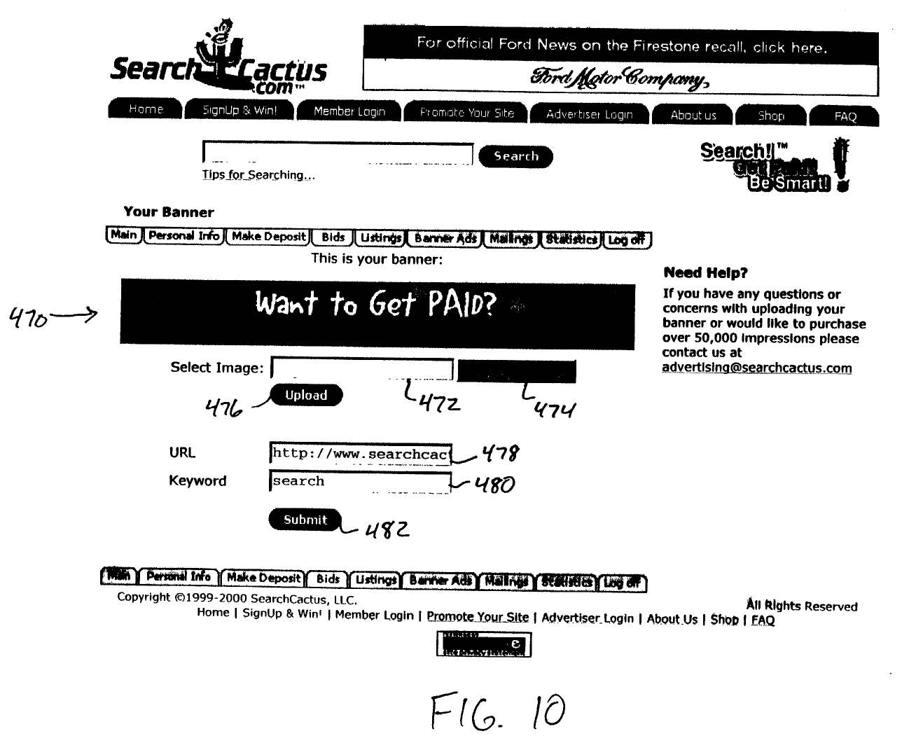

FIG. 10 illustrates banner ad management functions in greater detail for a search engine according to one embodiment of the present invention. As described with reference to FIG. 9, each banner ad preferably includes a graphic 470 which may be displayed in response to a particular keyword or search term entered by a user. Alternatively, banner ads may be periodically displayed regardless of the particular user search query. The graphic and/or text may be stored in a file specified in box 472. Button 474 provides a browsing function to navigate or select a file stored locally at the advertiser's computer. After specifying the file, upload button 476 is used to transfer the file to the search engine server. An associated link or URL 478 and keyword 480 are preferably associated with each banner ad.

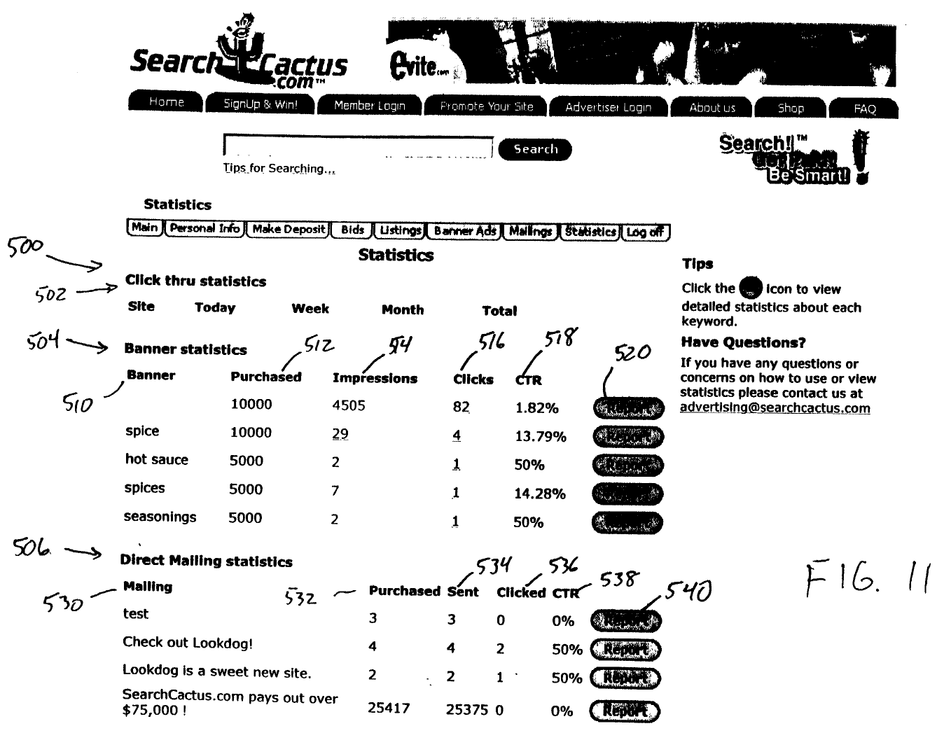

FIG. 11 illustrates an advertisers statistics summary report for a search engine according to one embodiment of the present invention. Statistics 500 preferably include click-through statistics for each site listing 502. Preferably, the click-through statistics include a summary report of click-through responses from users (registered and unregistered) for the day, week, month, and total). In addition to listing click-through statistics, banner statistics 504 are provided according to one preferred embodiment. Banner statistics preferably include each banner with the number of impressions or displays 512, the number of impressions displayed 514, the number of user responses 516, and the click-through rate 518 which is based on the number of responses 516 and the number of impressions 514. An associated button 520 is provided to compile and access a detailed report of demographic information corresponding to registered users who will respond to the advertisement.

Various other advertising campaign summary information may also be provided. For example, statistics for a direct electronic messaging or email campaign 506 are provided. Each direct email campaign is listed as indicated at 530. The number of users for a particular qualifying criteria associated with the direct mailing is indicated as 532. The number of messages sent is indicated at 534. The number of user responses is indicated at 536 with the corresponding click-through rate (CTR) 538. A report button 540 accesses demographic information associated with users who have responded to the particular mailing.

FIG. 12 illustrates a detailed demographic report for a search engine advertisement according to one embodiment of the present invention. Preferably, the report identifies the particular site listing 550 and associated type of advertising 552. A reporting period 554 may be selected by the advertiser for a particular report. After selecting the particular advertising campaign and period, demographic statistics associated with users who respond to the advertisement are accumulated and presented to the advertiser. Preferably, the advertising statistics are provided for each category 556 of information. Demographic categories 556 may include one or more ranges 558 which may be determined by the search engine and/or advertiser. Preferably, demographic information is provided for each category including numerical information 560 and associated graphical information 562. In one preferred embodiment of the present invention, demographic information includes the age group, gender, marital status, number of children, education level, income level, occupation, housing, number of hours spent online, number of online transactions completed, and hobbies. Of course, various other types of information may be collected by the search engine during the registration process, associated with a particular advertisement when a user responds to the advertisement, and accumulated and displayed in a statistical report in accordance with the present invention.

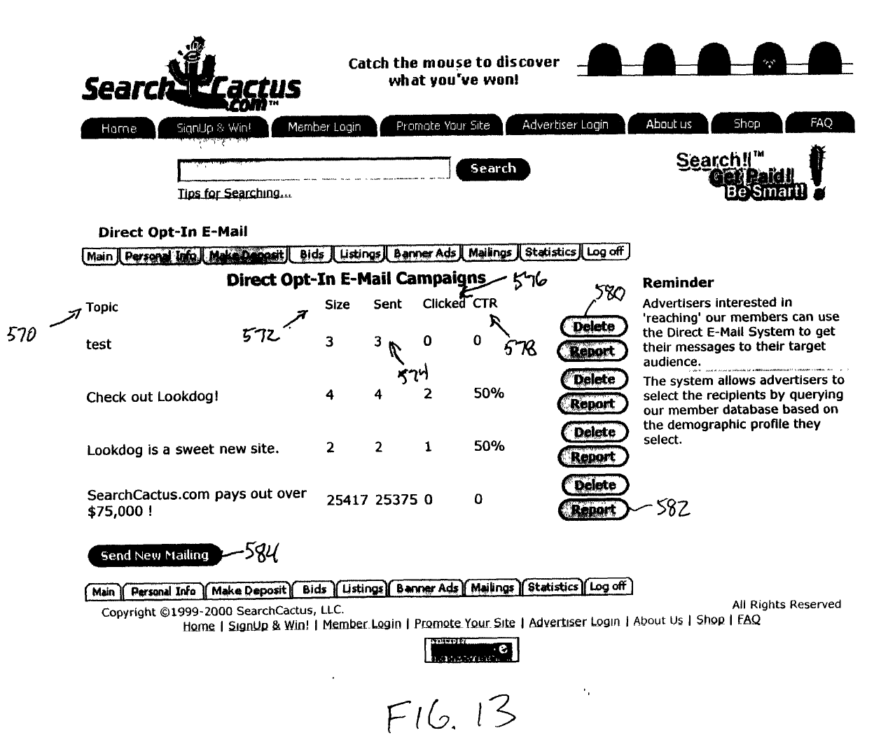

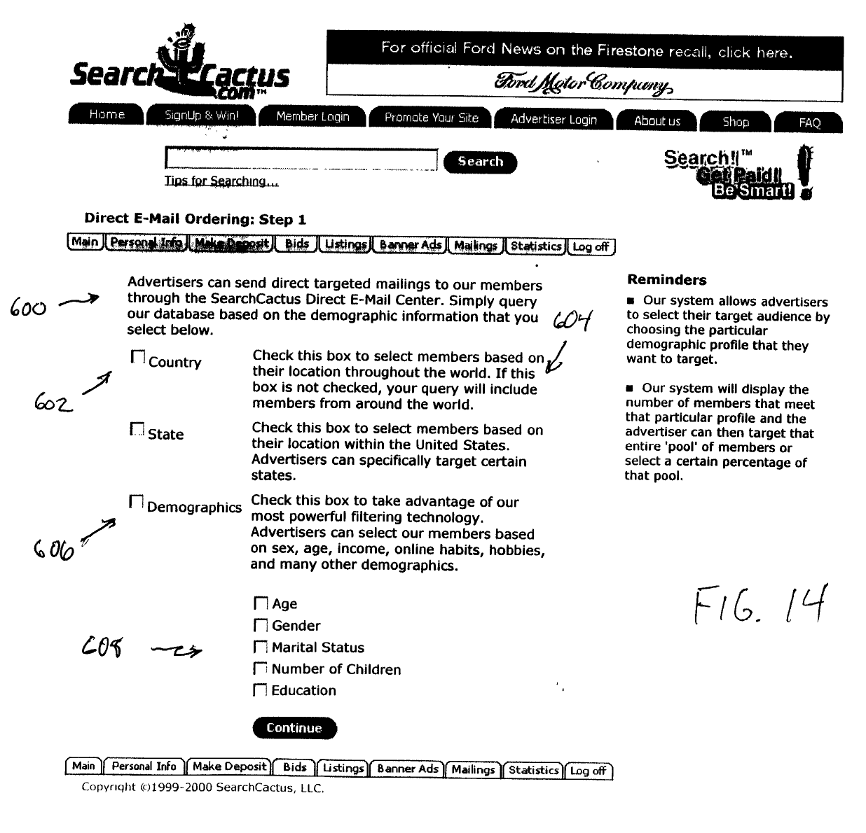

FIG. 13 illustrates a statistics summary for a direct email advertising campaign according to one embodiment of the present invention. Preferably, each email campaign includes a subject or topic 570 which may be used for identification purposes. The summary report preferably includes the number 572 of registered users selected for the campaign, the number of electronic messages 574, the number of responses 576, and the click-through rate 578. Buttons may be provided to facilitate various management features. In one preferred embodiment, a delete button 580, report button 582, and send button 584 are provided. Delete button 580 operates to delete the associated email message statistics. Report buttons 584 are used to provide a statistical summary report of the demographic information associated with those users who responded to the particular email. A “send new mailing” button 584 is provided to set up a new email campaign as illustrated and described with reference to FIGS. 14-18.

FIG. 14 illustrates a first step in establishing a new direct mail campaign through selection of demographic criteria. Instructions or other information 600 may be provided to assist in completing each step. Preferably, the advertiser selects various criteria to target an email message. Criteria may include regional information 602 with an associated description or instructions on how to select the information as represented by reference numeral 604. In addition, the selection criteria may include various types of demographic criteria 606. Demographic information may include any of a number of categories as illustrated in FIG. 13 and represented generally by reference numeral 608.

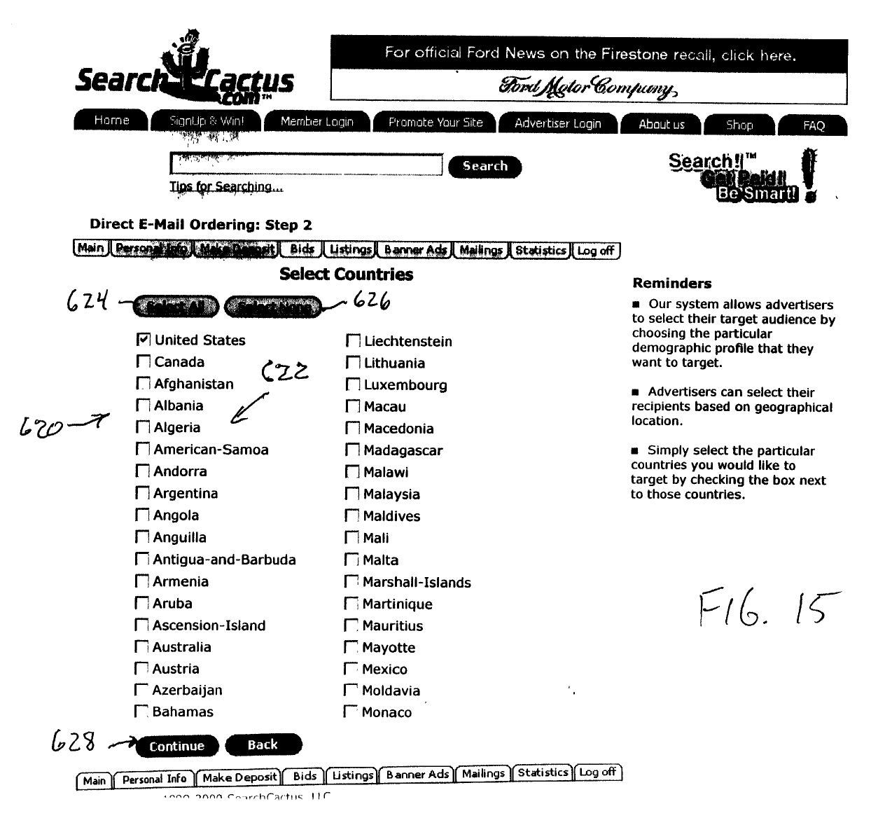

FIG. 15 illustrates a second step in establishing a direct mailing advertising campaign using demographic information according to one embodiment of the present invention. Various selection aids may be provided to select all 624 or to select none 626 of the geographic regions. Preferably, each selection includes a check box 620 and associated description or name 622. Additional navigational aids 628 may be provided to page forward or backward through the various selection criteria.

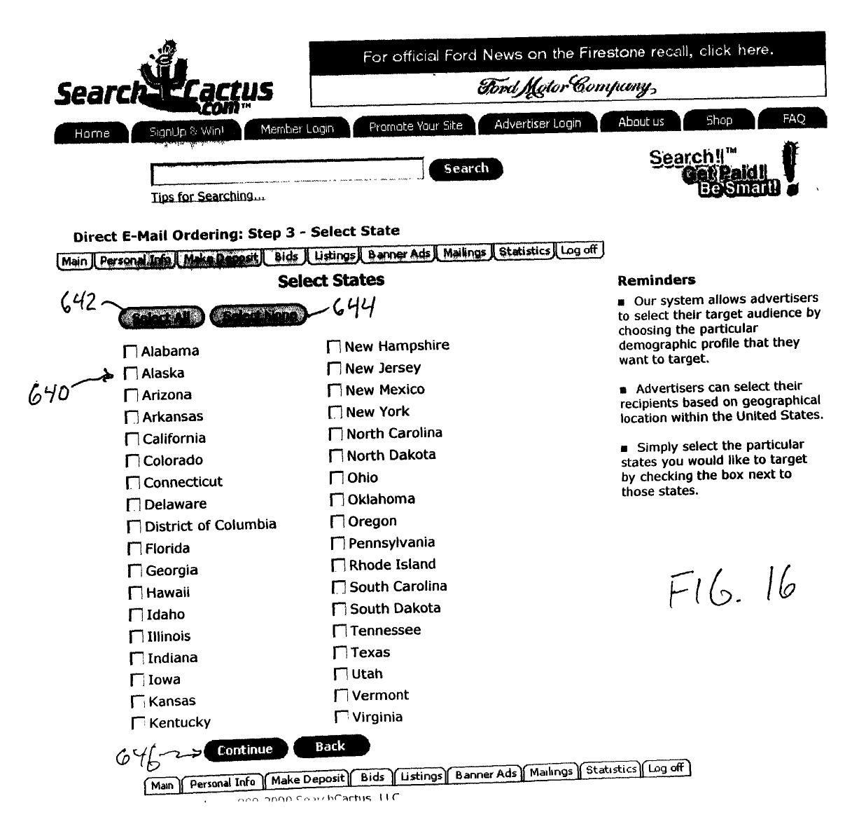

FIG. 16 illustrates selection of more specific geographic criteria for an email advertising campaign according to one embodiment of the present invention. Similar to the selections provided in FIG. 15, those provided in FIG. 16 may include selection aids 642 and 644 to select all, none, and/or a subset of geographic regions 640. Preferably, navigational buttons 646 are also provided to page forward or backward through the selection criteria.

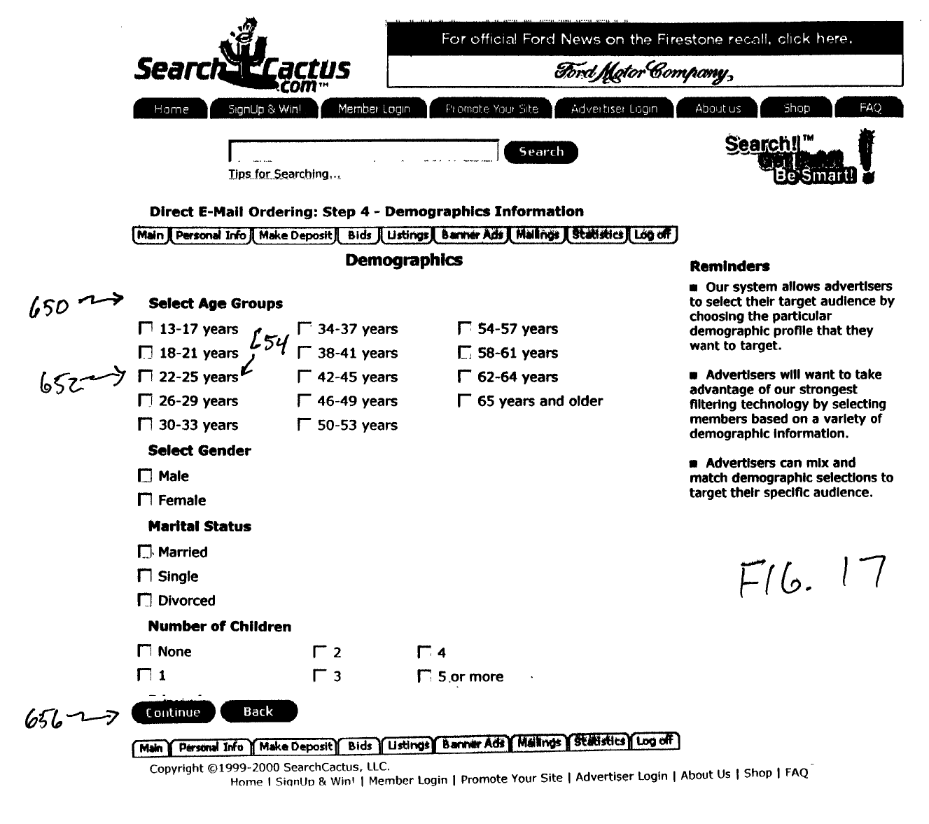

FIG. 17 illustrates selection of additional demographic criteria for an email advertising campaign according to one embodiment of the present invention. Demographic information 650 preferably includes selection boxes 652 and associated descriptions 654. The advertiser may select one or more groups or categories by checking corresponding boxes 652. Likewise, for each demographic category, such as age group, gender, marital status, and the like, the advertiser may select one or more groups. Navigational buttons for aids 656 are preferably provided to page forward or backward through the selection criteria.

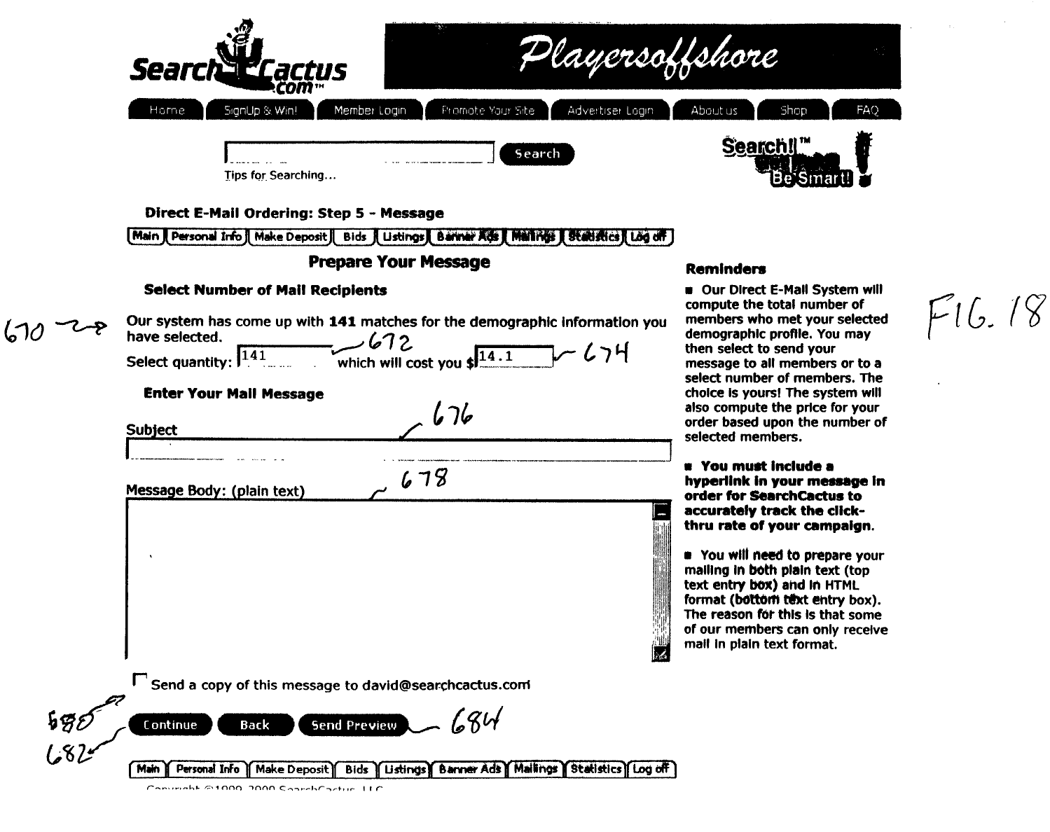

FIG. 18 illustrates preparation of an email advertisement including determination of pricing quantity based on demographic criteria according to one embodiment of the present invention. After the advertiser determines or selects the criteria for the email advertising campaign as illustrated and described with reference to FIGS. 14-17, the system searches the user database to select users which match the criteria. The number of matches 670 is presented or displayed. The advertiser may then select a subgroup of the matches by entering a number in the appropriate box 672. The system then calculates the cost and displays the cost in box 674. Alternatively, the advertiser may enter a cost in box 674 and the system will calculate or determine the number of messages which can be sent for that price. This number is then displayed in box 672. The selected quantity of users which will receive the electronic message is limited by the number of matches 670. The advertiser then may modify the selection criteria to increase or decrease the number of matches. If the advertiser selects a number in box 672 which is less than the total number of matches, the system will determine which users matching the selection criteria will receive the advertising message. This may be done alphabetically, randomly, or in any particular manner determined by the administrator.

After determining the number of users who will receive the message, a subject may be entered at 676 and the message body entered at 678. In one preferred embodiment, the message body may be entered in plain text or in a mark-up language such as HTML. Box 680 may be used to send a copy of the message to the advertiser. Navigational aids 682 may be provided to return to the selection criteria or to submit the message for approval by the system administrator. In addition, a preview of the message may be sent to the advertiser by activating button 684.

As such, the present invention provides advertisers with demographic statistics relative to users who respond to various types of advertising campaigns. The present invention therefore provides for more targeted advertising so advertising resources can be allocated to those campaigns which reach the intended recipients who responds to the advertisement. The present invention provides an incentive to the users to register as members and provide demographic information which can then be subsequently collected and provided in an anonymous fashion to the advertiser based on those users who respond to particular advertising campaigns. Because the advertisers are allowed to select keywords for search results listings and associated bid prices for relative placement in the results listings, the advertisers have more complete control over their advertising campaigns. Unlike other methods for advertising, the present invention supplies advertisers with real-time average demographic information for those users responding to their advertisements. The search engine encourages participation by members by rewarding members for registering and using the search engine based on responses to advertisements. The search engine preferably does not provide any identifiable personal information to the advertisers. Rather, personal information is kept strictly confidential with advertisers provided with only demographic information in an anonymous fashion.

While embodiments of the invention have been illustrated and described, it is not intended that these embodiments illustrate and describe all possible forms of the invention. Rather, the words used in the specification are words of description rather than limitation, and it is understood that various changes may be made without departing from the spirit and scope of the invention.

What is claimed is:

1. A method for electronic advertising associated with a search engine for searching a computer network, the method comprising:
providing an incentive to users of the search engine to provide demographic information; and
associating the demographic information with advertisements selected by the users.

2. The method of claim 1 wherein providing an incentive comprises crediting a user's account when the user responds to an advertisement.

3. The method of claim 1 wherein providing an incentive comprises crediting a user's account only after the user responds to an advertisement by visiting an associated website for a predetermined period of time.

4. The method of claim 2 further comprising determining whether the user meets predetermined criteria prior to crediting the user's account.

5. The method of claim 4 wherein the predetermined criteria include a maximum number of times the user may receive credit for visiting the associated website within a predetermined period of time.

6. The method of claim 4 wherein the predetermined criteria include a maximum number of credits the user may receive within a predetermined time.

7. The method of claim 1 further comprising debiting an advertiser's account when the user responds to an advertisement.

8. The method of claim 1 wherein providing an incentive comprises crediting a user's account when the user registers and provides demographic information.

9. The method of claim 1 further comprising debiting an advertiser's account for an amount determined by the advertiser for placement within a list of search results based on a search term entered by the user.

10. The method of claim 1 further comprising generating statistics related to the demographic information of users who respond to an advertisement.

11. The method of claim 1 further comprising:
selecting a group of users based on the demographic information; and
sending an electronic advertisement to the selected group of users.

12. The method of claim 1 further comprising:
selecting demographic criteria for an advertising campaign;
determining a number of users meeting the selected demographic criteria; and
sending an electronic advertisement to the users meeting the selected demographic criteria.

13. The method of claim 12 further comprising charging an advertiser based on the number of users meeting the demographic criteria.

14. The method of claim 12 further comprising charging an advertiser for each user that responds to the electronic advertisement.

15. A method for electronic advertising using a search engine for searching a computer network, the method comprising:
collecting demographic information from users of the search engine;
searching a database of advertiser listings with associated keywords and bid prices based on search terms entered by a user;
displaying advertiser listings with keywords matching the search terms in an order based at least on the bid prices; and
associating a user's demographic information with an advertiser listing when the user selects the advertiser listing.

16. The method of claim 15 further comprising crediting a user account for selecting the advertiser listing.

17. The method of claim 16 wherein the step of crediting the user account is performed only if the user meets predetermined criteria.

18. The method of claim 17 wherein the predetermined criteria include a minimum period of time the user is required to visit a website associated with the advertiser listing.

19. The method of claim 17 wherein the predetermined criteria include a maximum number of credits within a predetermined time.

20. The method of claim 17 wherein the predetermined criteria include a maximum number of credits for selecting a particular advertising listing within a predetermined period of time.

21. The method of claim 15 further comprising debiting an advertiser account for each user who selects the advertiser listing.

22. The method of claim 15 further comprising:
selecting demographic criteria for an advertising campaign;
determining a number of users meeting the demographic criteria;
selecting at least a subset of the users meeting the demographic criteria; and
sending email messages to the selected users meeting the demographic criteria.

23. The method of claim 22 wherein the email messages include a link to the search engine which is associated with an advertiser, the method further comprising determining a number of users who respond to the email messages.

24. The method of claim 23 further comprising generating statistical information based on the demographic information of users who respond to the email messages.

25. The method of claim 23 further comprising debiting an advertiser's account based on the number of users meeting the demographic criteria.

26. The method of claim 23 further comprising debiting an advertiser's account based on a number of users who respond to the email messages.

27. A computer readable storage medium having stored data representing instructions executable by a computer to integrate electronic advertising with a search engine for searching a computer network, the computer readable storage medium comprising:
instructions for collecting demographic information from users of the search engine;
instructions for searching a database of advertiser listings with associated keywords and bid prices based on search terms entered by a user;
instructions for displaying advertiser listings with keywords matching the search terms in an order based at least on the bid prices; and
instructions for associating a user's demographic information with an advertiser listing when the user selects the advertiser listing.

28. The computer readable storage medium of claim 27 further comprising instructions for crediting a user account for selecting the advertiser listing.

29. The computer readable storage medium of claim 28 wherein the instructions for crediting the user account include instructions for crediting the user account only if the user meets predetermined criteria.

30. The computer readable storage medium of claim 29 wherein the predetermined criteria include a minimum period of time the user is required to visit a website associated with the advertiser listing.

31. The computer readable storage medium of claim 29 wherein the predetermined criteria include a maximum number of credits within a predetermined time.

32. The computer readable storage medium of claim 29 wherein the predetermined criteria include a maximum number of credits for selecting a particular advertising listing within a predetermined period of time.

33. The computer readable storage medium of claim 27 further comprising instructions for debiting an advertiser account for each user who selects the advertiser listing.

34. The computer readable storage medium of claim 27 further comprising:
instructions for selecting demographic criteria for an advertising campaign;
instructions for determining a number of users meeting the demographic criteria;
instructions for selecting at least a subset of the users meeting the demographic criteria; and
instructions for sending email messages to the selected users meeting the demographic criteria.

35. The computer readable storage medium of claim 34 wherein the email messages include a link to the search engine which is associated with an advertiser, the computer readable storage medium further comprising instructions for determining a number of users who respond to the email messages.

36. The computer readable storage medium of claim 35 further comprising instructions for generating statistical information based on the demographic information of users who respond to the email messages.

37. The computer readable storage medium of claim 35 further comprising instructions for debiting an advertiser's account based on the number of users meeting the demographic criteria.

38. The computer readable storage medium of claim 35 further comprising instructions for debiting an advertiser's account based on a number of users who respond to the email messages.

39. A method for electronic advertising using a computer network, the method comprising:
providing an incentive for new users to voluntarily enter personal information including at least demographic information and an email address to become registered users;
storing the personal information of registered users in a searchable database;
receiving demographic selection criteria for an advertising campaign from an advertiser;
searching the database to determine the number of registered users meeting the demographic selection criteria;
reporting the number of registered users meeting the demographic selection criteria and a price for sending email to those registered users meeting the demographic selection criteria to the advertiser;
determining how many of the registered users meeting the demographic selection criteria will be sent email as part of the advertising campaign; and
sending email to the number of registered users selected by the advertiser and meeting the demographic selection criteria without providing the email addresses of the registered users to the advertiser.

40. The method of claim 39 wherein the step of sending email includes sending email including a link to a computer on the network, the method further comprising charging the advertiser based on the number of registered users who use the link to access the computer.

41. The method of claim 39 further comprising charging the advertiser based on how many of the registered users meeting the demographic selection criteria are sent the email.

42. The method of claim 39 wherein the step of providing an incentive comprises crediting a registered user's account for providing the personal information.

43. The method of claim 39 wherein the step of providing an incentive comprises crediting a registered user's account when the registered user visits a website associated with the advertiser.
